(19) United States
(12) Patent Application Publication
(10) Pub. No.: US 2008/0259839 A1
(43) Pub. Date: Oct. 23, 2008

(54) REDUNDANT WIRELESS BASE STATION

(75) Inventors: Shaohua Tang, Sammamish, WA (US); Eamonn F. Gormley, Redmond, WA (US)

Correspondence Address: HOLLAND & KNIGHT LLP, 10 ST. JAMES AVENUE, 11th Floor, BOSTON, MA, 02116-3889, US

(73) Assignee: SR Telecom Inc., Montreal (CA)

(21) Appl. No.: 11/971,455

(22) Filed: Jan. 9, 2008

Related U.S. Application Data
(60) Provisional application No. 60/884,090, filed on Jan. 9, 2007.

(51) Int. Cl. H04Q 7/00

(52) U.S. Cl. 370/312

(57) ABSTRACT

In a redundant wireless base station, a redundancy parameter solicitation is sent by a first baseband processing unit via a multicast to a local area network including at least a second baseband processing unit. Advertised redundancy parameters are received via a multicast to the local area network from the second baseband processing unit.

### CROSS-REFERENCE TO RELATED APPLICATIONS

This application claims the benefit of U.S. provisional patent application Ser. No. 60/884,090, filed Jan. 9, 2007, the entire disclosure of which is incorporated herein by reference.

### TECHNICAL FIELD

The present invention relates to wireless networks, and more particularly to redundant wireless base stations.

### BACKGROUND OF THE DISCLOSURE

Wireless networks may be used for providing a wireless link between a base station and one or more subscriber stations. The base station typically includes a baseband processing unit and an outdoor unit. The baseband processing unit may receive data from a network and generate an RF signal based upon the data. The generated RF signal may be passed to the outdoor unit, which may include a radio for transmitting the data to the one or more subscriber stations via the wireless link. Similarly, the outdoor unit may receive wireless transmissions from one or more subscriber stations, and may pass an RF signal to the baseband processing unit. The baseband processing unit may, in turn, transmit data to the network, in which the data is based upon the RF signal.

In the event of a failure in the baseband processing unit, it is typically necessary to send a technician to the base station to remedy the problem. Unfortunately, during the time period between the occurrence of the problem and the correction of the problem by the technician, the wireless network is down, preventing the exchange of data between the base station and the one or more subscriber stations. Accordingly, it would be desirable to provide redundancy in the base station, to allow the wireless network to continuing operating after the failure of a baseband processing unit.

### SUMMARY OF THE DISCLOSURE

According to a first implementation a system includes a first baseband processing unit coupled to at least a first radio unit, and a second baseband processing unit coupled to at least a second radio. A link couples the first baseband processing unit and the second baseband processing unit, in which the link allows at least one of the first baseband processing unit and the second baseband processing unit to one or more of transmit and receive via the first radio unit and the second radio unit. A buffer is associated with the link. The buffer is configured to synchronize one or more of transmission and reception via the first radio unit and the second radio unit.

One or more of the following features may be included. The link may enable sending and receiving RF radio data to and from one or more of the first and the second radio. The link may include an open base station architecture institute (OBSAI) link. The link may include an IF interface using coaxial connections. The link may include an IEEE 802.3 Ethernet link. The link may include a common public radio interface (CPRI) link.

The buffer may be incorporated into one of the first baseband processing unit and the second baseband processing unit. The first baseband processing unit may be an active baseband processing unit and the second baseband processing unit may be a standby baseband processing unit of a redundant base station system. The buffer may provide a signal delay in a RF signal between the first baseband processing unit and the first radio unit.

According to another implementation, a wireless network includes one or more subscriber stations coupled to a redundant wireless base station via a wireless link. The redundant wireless base station includes a first baseband processing unit coupled to at least a first radio unit, and a second baseband processing unit coupled to at least a second radio. The first baseband processing unit and the second baseband processing unit are coupled by a link allowing at least one of the first baseband processing unit and the second baseband processing unit to one or more of transmit and receive via the first radio unit and the second radio unit. A buffer is associated with the link, and the buffer is configured to synchronize one or more of transmission and reception via the first radio unit and the second radio unit.

One or more of the following features may be included. The link may enable sending and receiving RF radio data to and from one or more of the first and the second radio. The link may include an open base station architecture institute (OBSAI) link. The link may include an IF interface using coaxial connections. The link may include an IEEE 802.3 Ethernet link. The link may include a common public radio interface (CPRI) link.

The buffer may be incorporated into one of the first baseband processing unit and the second baseband processing unit. The first baseband processing unit may be an active baseband processing unit and the second baseband processing unit may be a standby baseband processing unit of a redundant base station system. The buffer may provide a signal delay in a RF signal between the first baseband processing unit and the first radio unit.

The details of one or more implementations are set forth in the accompanying drawings and the description below. Other features and advantages will become apparent from the description, the drawings, and the claims.

### BRIEF DESCRIPTION OF THE DRAWINGS

FIG. 1 diagrammatically depicts a wireless network including a redundant base station and a plurality of subscriber stations.

FIG. 2 diagrammatically depicts hardware signals between baseband processing units of the redundant base station of FIG. 1.

FIG. 3 is a flow chart of a process executed by the system management process, and/or one or more of the baseband processing units of the redundant base station of FIG. 1.

FIG. 4 is a flow chart of a process executed by the solicitation process and/or one or more of the baseband processing units of the redundant base station of FIG. 1.

### DETAILED DESCRIPTION OF THE PREFERRED EMBODIMENTS

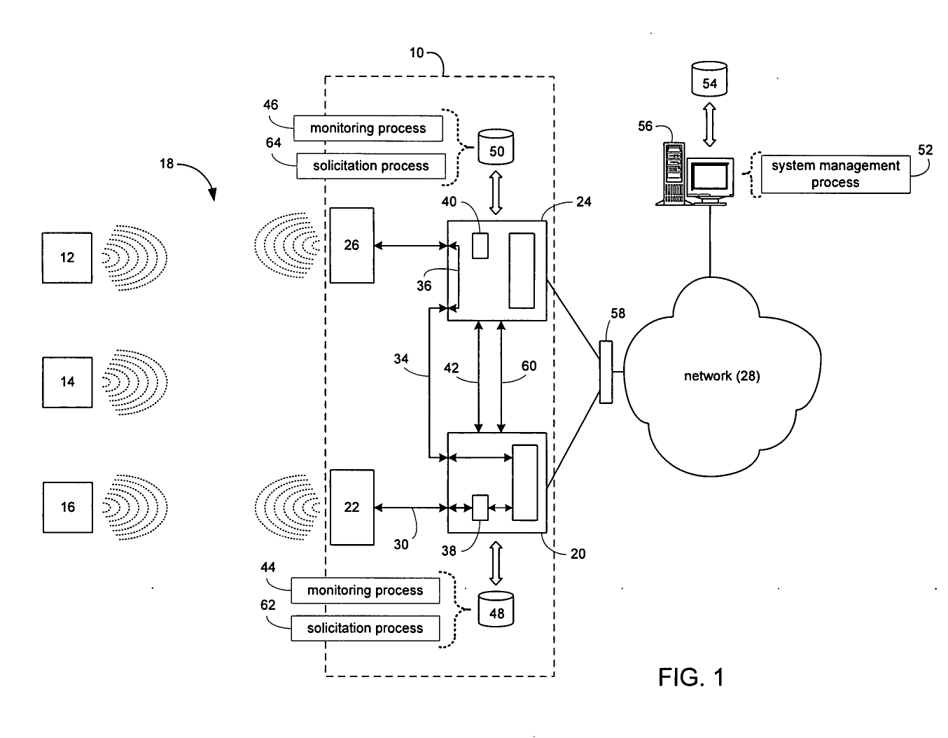

Referring to FIG. 1, there is shown a wireless network including redundant bases station 10 configured to communicate with one or more subscriber stations (e.g., subscriber stations 12, 14, 16) over wireless link 18. The wireless network may include, for example, a broadband wireless network (e.g., a WiMAX network as standardized by IEEE 802.16), a cellular communication network, or the like.

Redundant base station 10 may include a first baseband processing unit (e.g., baseband processing unit 20) coupled to a first radio unit (e.g., radio unit 22) and a second baseband processing unit (e.g., baseband processing unit 24) coupled to a second radio unit (e.g., radio unit 26). Baseband processing units 20, 24 may be coupled to network 28, which may include, for example, the Internet, a local area network (LAN), a wide are network (WAN), a public switched telephone network (PSTN), or the like. Baseband processing units 20, 24 may receive data from network 28 and generate RF radio frequency (RF) signal for driving radio units 22, 26. Similarly, baseband processing units 20, 24 may receive RF signals from radio units 22, 26 and transmit data represented by the RF signals to network 28.

Redundant base station 10 may provide redundancy by defining one baseband processing unit (e.g., baseband processing unit 20) as an active baseband processing unit and the other baseband processing unit (e.g., baseband processing unit 24) as a standby baseband processing unit. Active baseband processing unit 20 may communicate with subscriber stations 12, 14, 16 via wireless link 18. In the event of a failure of active baseband processing unit 20, standby baseband processing unit 24 may assume the role of the active baseband processing unit to continue communications with subscriber stations 12, 14, 16. During normal operation, only one baseband processing unit may be an active baseband processing unit.

Baseband processing unit 20 may be coupled to radio unit 22 via link 30, e.g., for passing RF signals between baseband processing unit 20 and radio unit 22. Similarly, baseband processing unit 24 may be coupled to radio unit 26 by link 32, e.g., for passing RF signals between baseband processing unit 24 and radio unit 26. Continuing with the above-stated example, the active baseband processing unit (e.g., baseband processing unit 20) may transmit via both radio unit 22, to which baseband processing unit 20 is coupled, and radio unit 26, to which baseband processing unit 24 is coupled. Baseband processing units 20, 24 may be coupled by a link (e.g., link 34) allowing baseband processing unit 20 to transmit and/or receive base band RF signals to/from radio unit 26. Baseband processing unit 24 may include a pass-through 36 coupling links 32, 34.

Links 30, 32, 34 may include, for example, one or more of Open Base Station Architecture Institute (OBSAI) links, standard IF interface using a coaxial connection instead of a fiber optic link, a proprietary optical or electrical interface, and IEEE 802.3 based Ethernet link including, but not limited to 1000BaseSx for baseband radio signal transmissions, Common Public Radio Interface (CPRI), or the like.

Transmissions from radio units 22, 26 may be synchronized in time with one another when they are transmitted over the air. Similarly, RF signals from radio units 22, 26 for transmissions received from subscriber stations 12, 14, 16 may be synchronized in time when they arrive at active baseband processing unit 20. Baseband processing unit 20 may include buffer 38 for synchronizing transmissions by radio units 22, 26 and received RF signals from radio units 22, 26. For example, the propagation delay from baseband processing unit 20 to radio unit 22 via link 30, may be shorter than the propagation delay from baseband processing unit to radio unit 26 via links 34, 32 and pass-through 36. Buffer 38 may introduce a delay between baseband processing unit 20 and radio unit 22 that is equal to the difference in the propagation delay from baseband processing unit 20 to radio unit 22 and the propagation delay from baseband processing unit 20 to radio unit 26. Accordingly, buffer 38 may allow for synchronized transmission and/or reception via radio unit 22 and radio unit 26. In a similar manner, baseband processing unit 24 may include buffer 40, e.g., which may compensate for differences in propagation delay allowing baseband processing unit 24 to transmit and/or receive via both radio units (e.g., radio units 22, 26), for example in a situation in which baseband processing unit 24 may be an active baseband processing unit.

Baseband processing units 20, 24 may additionally include link 42, e.g., which may pass hardware signals between baseband processing units 20, 24. Link 42 may be configured to communicate activity status information, operational status information, and reset control signals between baseband processing unit 20 and baseband processing unit 24.

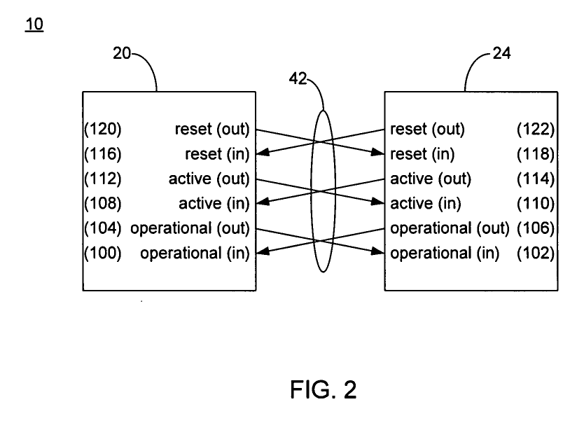

For example, and referring also to FIG. 2, link 42 may include an operational status input (e.g., operational (in) 100, 102) and an operational status output (e.g., operational (out) 104, 106) for each of baseband processing units 20, 24. Similarly, link 42 may include an activity status information input (e.g., active (in) 108, 110) and an activity status information output (e.g., active (out) 112, 114) for each of baseband processing units 20, 24. Link 42 may also include a reset control signal input (e.g., reset (in) 116, 118) and a reset control signal output (e.g., reset (out) 120, 122) for each of baseband processing units 20, 24. Link 42 may include a hardwire link between baseband processing unit 20 and baseband processing unit 22, e.g., implemented as a six (or more) conductor communication cable, such as an Ethernet cable, or the like.

As shown, operational (out) 104 of baseband processing unit 20 may be coupled to operational (in) 102 of baseband processing unit 24 for communicating operational status information about baseband processing unit 20 to baseband processing unit 24. Similarly, operational (out) 106 of baseband processing unit 24 may be coupled to operational (in) 100 of baseband processing unit 20 for communicating operational status information about baseband processing unit 24 to baseband processing unit 20. The operational status information may indicate an operational status of one of baseband processing units 20, 24 to the other of baseband processing units 20, 24. The operational status information may, for example, indicate whether the baseband processing unit is operational (e.g., via a binary signal or the like). The operational status information allow a standby baseband processing unit (e.g., baseband processing unit 24) to take over the active role in the even that the active baseband processing unit (e.g., baseband processing unit 20) experiences a failure (e.g., as indicated by a change in the state of the operational status information), or otherwise becomes inoperable.

The operational status information provided to a peer baseband processing unit (e.g., via operational (out) 104, 106) may be monitored by a system state monitoring process (e.g., monitoring process 44, 46). Monitoring process 44, 46 may reside on a storage device (e.g., storage device 48, 50) coupled to the respective baseband processing unit 20, 24. Monitoring process 44, 46 may monitor the operational status of the respective baseband processing unit 20, 24. In the event of a severe failure or change in operational status of the baseband processing unit 20, 24, monitoring process 44, 46 may generate a corresponding operational status information signal (e.g., a change in a binary state). The operational status information signal may be transmitted via operational (out) 104, 106 and may be received at operational (in) 100, 102 of the peer baseband processing unit. The operational status information may allow faster responses to failure.

The instruction sets and subroutines of monitoring processes 44, 46 may be stored on storage devices 48, 50 (respectively) and may be executed by one or more processors (not shown) and one or more memory architectures (not shown) incorporated into baseband processing units 20, 24 (respectively). Storage devices 48, 50 may include, but are not limited to, hard disk drives; tape drives; optical drives; RAID arrays, random access memories (RAM); read-only memories (ROM); flash memory storage devices, and the like.

As shown, active (out) 112 of baseband processing unit 20 may be coupled to active (in) 110 of baseband processing unit 24 for communicating activity status information of baseband processing unit 20 to baseband processing unit 24. Similarly, active (out) 114 of baseband processing unit 24 may be coupled to active (in) 108 of baseband processing unit 20 for communicating activity status information of baseband processing unit 24 to baseband processing unit 20. The activity status information may indicate an activity status of one or baseband processing units 20, 24 to the other of baseband processing units 20, 24. The activity status information may indicate whether the baseband processing unit is in an active baseband processing unit role or a standby baseband processing unit role. If a first baseband processing unit (e.g., baseband processing unit 20) is in an active baseband processing unit role (e.g., as indicated by an activity status information signal, e.g., which may be a binary signal), the second baseband processing unit (e.g., baseband processing unit 24) may not transmit and may activate pass-though 36 allowing baseband processing unit 20 to drive both radio units 22, 26. As such the activity status information may prevent a situation in which there are two active baseband processing units, e.g., which may attempt to simultaneously transmit via their respective radio units.

The reset control signal may enable one of baseband processing units 20, 24 to reset the other of the baseband processing units 20, 24. The reset control signal maybe a hardware control signal, and may, therefore, allow one baseband processing unit (e.g., baseband processing unit 20) to reset the other baseband processing unit (e.g., baseband processing unit 24) even in the event of a software failure or problem. Reset (out) 120 of baseband processing unit 20 may be coupled to reset (in) 118 of baseband processing unit 24 allowing baseband processing unit 20 to communicate a reset control signal to baseband processing unit 24. Similarly, reset (out) 122 of baseband processing unit 24 may be coupled to reset (in) 116 of baseband processing unit 20 allowing baseband processing unit 24 to communicate a reset control signal to baseband processing unit 20.

The reset control signal may include, for example, a binary signal which may allow a first baseband processing unit (e.g., baseband processing unit 20) to reset the other baseband processing unit (e.g., baseband processing unit 24), e.g., via a change in state of a binary signal. Of course, reset control signals other than binary control signals may be equally utilized. Baseband processing units 20, 24 may communicate with and/or may be monitored by a system management process (e.g., system management process 52). In response to detecting a problem or failure with one of the baseband processing units (e.g., baseband processing unit 24), system management process 52 may instruct the other baseband processing unit (e.g., baseband processing unit 20) to reset baseband processing unit 24. In response to the instructions from system management process 52, baseband processing unit 20 may toggle the reset control signal (e.g., which may be communicated to baseband processing unit 24 via reset (out) 120 and reset (in) 118) causing one or more processors (not shown) or software operations (not shown) of baseband processing unit 24 to be restarted. As such, it may not be necessary to dispatch a technician to redundant base station 10 to manually restart baseband processing unit 24.

System management process 52 may reside on and may be executed by a server computer (e.g., server computer 54) connected to network 28. Examples of server computer 54 may include, but are not limited to: a personal computer, a server computer, a series of server computers, a mini-computer; and a mainframe computer. The instruction sets and subroutines of system management process 52 may be stored on storage device 56 and may be executed by one or more processors (not shown) and one or more memory architectures (not shown) incorporated into server computer 54. Storage device 56 may include, but is not limited to, hard disk drives; tape drives; optical drives; RAID arrays, random access memories (RAM); read-only memories (ROM); flash memory storage devices, and the like.

As mentioned above, redundant base station 10 may carry subscriber traffic between the one or more subscriber stations 12, 14, 16 and network 28, e.g., which may include the Internet, a WAN, a LAN, a PSTN, or the like. In redundant base station 10, both of baseband processing units 20, 24 may be connected to network 28. However, generally only one of baseband processing units 20, 24 may be an active baseband processing unit, e.g., which may transmit subscriber traffic (received from network 28) to one or more of subscriber station 12, 14, 16 and receive subscriber traffic (to be forwarded to network 28) from one or more of subscriber stations 12, 14, 16. As such, subscriber traffic should be forwarded only to the active one of baseband processing units 20, 24. System management process 52, alone or in conjunction with one or more of baseband processing units 20, 24 and/or any additional components of the wireless network, may allow subscriber traffic to be forwarded to the active baseband processing unit.

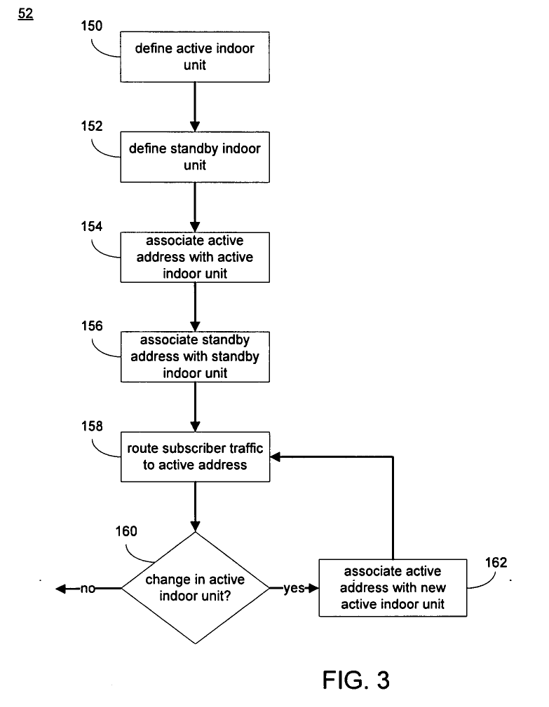

Referring also to FIG. 3, system management process 52 (alone or in conjunction with one or more of baseband processing units 20, 24) may define 150 an active baseband processing unit, and may define 152 a standby baseband processing unit. For example, based upon, at least in part, a designation by system management process 52 and/or an operational status and/or active status, baseband processing unit 20 may be defined 150 as an active baseband processing unit and baseband processing unit 24 may be defined 152 as a standby baseband processing unit. System management process 52 may associate 154 an active address with baseband processing unit 20 and may associate 156 a standby address with baseband processing unit 24.

The active address associated 154 with baseband processing unit 20 may include an Internet Protocol (IP) address and/or a media access control (MAC) address. Similarly, the standby address associated 156 with baseband processing unit 24 may also include an IP address and/or a MAC address. System management process 52 may route 158 subscriber traffic to the active address associated with active baseband processing unit 20. As such, subscriber traffic from network 28 may be forwarded to baseband processing unit 20 (e.g., by an edge device such as router 58) via the active address. That is, subscriber traffic from network 28 may be forwarded to the active address, which is associated 154 with baseband processing unit 20.

System management process 52 and/or one or more of baseband processing units 20, 24 may determine 160 if there has been a change in the active baseband processing unit. For example, baseband processing unit 20, which had been defined 150 as being the active baseband processing unit, may experience a failure. Based upon the failure of baseband processing unit 20, baseband processing unit 24, which had been defined 152 as being the standby baseband processing unit, may become the active baseband processing unit. As such, system management process 52 and/or one or more of baseband processing units 20, 24 may determine 160 that baseband processing unit 24 is now an active baseband processing unit.

In response to determining 160 that baseband processing unit 24 has become the active baseband processing unit, system management process 52 and/or one or more of baseband processing units 20, 24 may associate 162 the active address with baseband processing unit 24 and the standby address with baseband processing unit 20. As the active address may now be associated with baseband processing unit 24, subscriber traffic from network 28 may be routed 158 to baseband processing unit 24, with which the active address is now associated 162. Swapping addresses (i.e., associating 162 the active address with baseband processing unit 24 and the standby address with baseband processing unit 20) may be coordinated between baseband processing units 20, 24 via system management process 52. Additionally/alternatively, swapping addresses may be coordinated between baseband processing units 20, 24 via communication link 60 (e.g., a local Ethernet link, or similar communication link).

Accordingly, subscriber traffic from network 28 may always be routed 158 to the active address. The active address may be associated 154, 162 with whichever of baseband processing units 20, 24 is the active baseband processing unit. Upon a change in active status and standby status of baseband processing units 20, 24, baseband processing units 20, 24 may swap addresses, such that the active baseband processing unit owns the active address and the standby baseband processing unit owns the standby address. Therefore, subscriber traffic from network 28 may always be routed 158 to the same address (i.e., the active address) for transmission to the one or more subscriber stations 12, 14, 16 via wireless link 18.

Referring back to FIG. 1, baseband processing units 20, 24 may each execute a redundancy parameter solicitation process (e.g., solicitation processes 62, 64). Solicitation processes 62, 64 may allow for the automatic acquisition of redundancy parameters by one or more of baseband processing units 20, 24, e.g., which may, at least in part, obviate manual configuration of one or more of baseband processing units 20, 24. Solicitation processes 62, 64 may reside on storage devices 48, 50, coupled to baseband processing units 20, 24 (respectively). The instruction sets and subroutines of solicitation processes 62, 64 may be executed by one or more processors (not shown) and one or more memory architectures (not shown) incorporated within baseband processing units 20, 24.

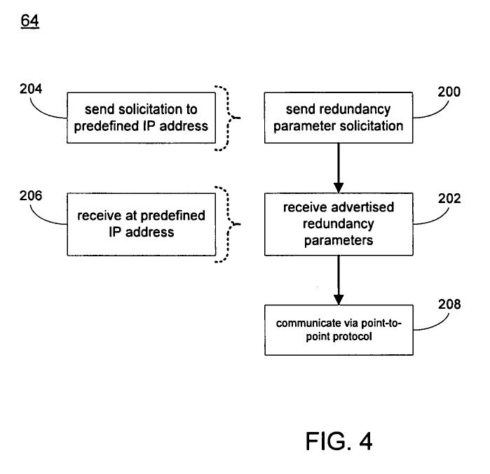

Assume, for example, baseband processing unit 20 is an active baseband processing unit, and baseband processing unit 24 is a newly added baseband processing unit, e.g., added to redundant base station 10 to provide redundancy for baseband processing unit 20. Referring also to FIG. 4, when baseband processing unit 20 is added to redundant base station 10 (or otherwise brought to an operational status), solicitation process 64 may send 200 a redundancy parameter solicitation via a multicast to a local area network (e.g., including baseband processing units 20, 24 and router 58). Solicitation process 62 may receive the redundancy parameter solicitation sent 200 by solicitation process 64. Based upon, at least in part, configuration and optional authentication, solicitation process 62 (e.g., which may be executed on an operational baseband processing unit) may advertise the redundancy parameters by multicasting an advertisement to the LAN. Solicitation process 64 may receive 202 the advertised redundancy parameters and may utilize the received 202 redundancy parameters for configuring baseband processing unit 24 to be a redundant baseband processing unit for baseband processing unit 20.

Multicasting the redundancy parameter solicitation and the redundancy parameter advertisement may use user datagram protocol (UDP) over IP. In such an example, sending 200 the redundancy parameter solicitation may include sending 204 the redundancy parameter solicitation to a predefined multicast IP address, with a predefined UDP destination port number. Similarly, receiving 202 the advertised redundancy parameters may include receiving 206 the advertised redundancy parameters on a predefined IP address, with a predefined UDP destination port number.

As mentioned, the advertised redundancy parameters may include parameters and/or configuration settings, e.g., which may enable baseband processing unit 24 to be automatically configured to provide redundancy for baseband processing unit 20 in redundant base station 10. Examples of redundancy parameters may include, but are not limited to: the active baseband processing unit's IP address, the standby baseband processing unit's IP address, and the subnet mask for the local Ethernet interface; the active baseband processing unit's IP address, the standby baseband processing unit's IP address, and the subnet mask of a Gig-bit Ethernet interface between the active baseband processing unit and the standby baseband processing unit; necessary parameters for the operations of virtual router redundancy protocol (VRRP) and rapid spanning tree protocol (RSTP); and a default gateway IP address for data forwarding.

Once at least a portion of the redundancy parameters have been received 202 via the multicasted advertisement, additional redundancy data (and/or other communications) may be communicated via a peer point-to-point protocol. For example, baseband processing units 20, 24 may communicate directly with one another (e.g., as opposed to communicating via multicast messages) via router 58, or directly via link 60.

A number of implementations have been described. Nevertheless, it will be understood that various modifications may be made. Accordingly, other implementations are within the scope of the following claims.

What is claimed is:

1. A method comprising:
sending, by a first baseband processing unit, a redundancy parameter solicitation via a multicast to a local area network including at least a second baseband processing unit; and
receiving advertised redundancy parameters via a multicast to the local area network from the second baseband processing unit.

2. The method of claim 1, wherein the first baseband processing unit includes a standby baseband processing unit of a redundant base station.

3. The method of claim 1, wherein the second baseband processing unit includes an active baseband processing unit of a redundant base station.

4. The method of claim 1, wherein sending a redundancy parameter solicitation includes multicasting the redundancy parameter solicitation to a predefined internet protocol (IP) address.

5. The method of claim 1, wherein receiving advertised redundancy parameters via a multicast includes receiving the advertised redundancy parameters on a predefined IP address.

6. The method of claim 1, further including communicating additional redundancy data via a peer point-to-point protocol.

7. A computer program product residing on a computer readable medium having a plurality of instructions stored thereon, which, when executed by a processor, cause the processor to perform operations comprising:
sending, by a first baseband processing unit, a redundancy parameter solicitation via a multicast to a local area network including at least a second baseband processing unit; and
receiving advertised redundancy parameters via a multicast to the local area network from the second baseband processing unit.

8. The computer program product of claim 7, wherein the first baseband processing unit includes a standby baseband processing unit of a redundant base station.

9. The computer program product of claim 7, wherein the second baseband processing unit includes an active baseband processing unit of a redundant base station.

10. The computer program product of claim 7, wherein the instructions for sending a redundancy parameter solicitation include instructions for multicasting the redundancy parameter solicitation to a predefined internet protocol (IP) address.

11. The computer program product of claim 7, wherein the instructions for receiving advertised redundancy parameters via a multicast include instructions for receiving the advertised redundancy parameters on a predefined IP address.

12. The computer program product of claim 7, further including communicating additional redundancy data via a peer point-to-point protocol.

13. A wireless network comprising:
one or more subscriber stations coupled to a redundant wireless base station via a wireless link;
the redundant base station including a first baseband processing unit configured to send a redundancy parameter solicitation via a multicast to a local area network, and a second baseband processing unit configured to transmit a redundancy parameter advertisement via a multicast to the local are network in response to, at least in part, the redundancy parameter solicitation.

14. The wireless network of claim 13, wherein the first baseband processing unit is further configured to receive the redundancy parameter advertisement from the second baseband processing unit.

15. The wireless network of claim 13, wherein the first baseband processing unit includes a standby baseband processing unit of a redundant base station.

16. The wireless network of claim 13, wherein the second baseband processing unit includes an active baseband processing unit of a redundant base station.

17. The wireless network of claim 13, wherein sending the redundancy parameter solicitation includes multicasting the redundancy parameter solicitation to a predefined internet protocol (IP) address.

18. The wireless network of claim 14 wherein the first baseband processing unit is configured to receive the advertised redundancy parameters via a multicast on a predefined IP address.

19. The wireless network of claim 13, wherein the first baseband processing unit and the second baseband processing unit are further configured to communicate additional redundancy data via a peer point-to-point protocol.
